(19) United States
(12) Patent Application Publication
(10) Pub. No.: US 2021/0299899 A1
(43) Pub. Date: Sep. 30, 2021

(54) CUTTING DEVICE AND RECORDING DEVICE

(71) Applicant: SEIKO EPSON CORPORATION, Tokyo (JP)

(72) Inventors: Shun ITO, Shiojiri-Shi (JP); Hitoshi IGARASHI, Shiojiri-Shi (JP)

(21) Appl. No.: 17/208,204

(22) Filed: Mar. 22, 2021

(30) Foreign Application Priority Data
Mar. 25, 2020 (JP) 2020-054401

(51) Int. Cl. B26D 1/04

(52) U.S. Cl. CPC B26D 1/045

(57) ABSTRACT

A cutting device includes a cutter carriage with a cutter blade that is capable of moving in a moving direction, a driving roller that is downstream of the cutter carriage and is configured to transport the medium, a support unit that is configured to support the medium, and a cover provided in a switchable manner between a first state and a second state. In the first state, the cover is configured to support the medium by covering a passage region for the cutter carriage that is formed between a downstream end of the support unit and the transport mechanism. In the second state, the cover opens the passage region by retracting from a position in the first state. An abutting portion is arranged in a gap formed between the cover and the driving roller, and is configured to abut on the medium from below in a height direction.

The present application is based on, and claims priority from JP Application Serial Number 2020-054401, filed Mar. 25, 2020, the disclosure of which is hereby incorporated by reference herein in its entirety.

### BACKGROUND

### 1. Technical Field

The present disclosure relates to a cutting device and a recording device including the cutting device.

### 2. Related Art

For example, as one example of a cutting device included in a recording device, JP-A-2009-179036 discloses a cutter device including a cutter blade and a cutter carriage that is provide movably in a direction orthogonal to a transport direction of a recording medium. The cutter device has an opening being a space for forming a passage region for the cutter carriage. The opening is provided with a cover capable of perform switching between a first state in which the cover covers the opening and forms part of a medium support surface and a second state in which the cover is retracted from the first state and forms the passage region of the cutter carriage. Further, when the recording medium is cut, the cutter carriage presses downs the cover in the first state while moving. With this, the cover is in the second state.

In the cutter device described above, in order to transport the recording medium, which is cut by the cutter blade, further downstream of the cutter blade, a driving roller is provided downstream of the cover in some cases, as one example of a transport mechanism. In this case, a gap is formed between a downstream end of the cover and the drive roller. Thus, a leading edge of the recording medium, which is cut by the cutter blade, passes downstream through a position of the downstream end of the cover, and then, for example, enters the space between the downstream end of the cover and the drive roller, which may cause a risk of hindering the drive roller from further transporting the recording medium downstream.

### SUMMARY

In order to solve the above-mentioned problems, a cutting device includes a cutter carriage including a cutter blade configured to cut a medium, and being provided movably in a moving direction intersecting a transport direction in which the medium is transported, a transport mechanism being provided downstream of the cutter carriage in the transport direction, and being configured to transport the medium in the transport direction, a support unit being provided upstream of the cutter carriage in the transport direction, and configured to support the medium, a cover being provided in a switchable manner between a first state and a second state, the first state being a state in which the cover is configured to support the medium by covering a passage region for the cutter carriage that is formed between a downstream end of the support unit in the transport direction and the transport mechanism, the second state being a state in which the cover opens the passage region by retracting from a position in the first state, and an abutting portion being arranged in a gap formed between a downstream end of the cover in the transport direction and the transport mechanism, and being configured to abut on the medium from below in a height direction intersecting the transport direction and the moving direction.

A recording device for solving the problem described above includes the cutting device described above having the above-mentioned configuration, and a recording unit configured to perform recording onto the medium.

### BRIEF DESCRIPTION OF THE DRAWINGS

FIG. 1 is a side view schematically illustrating an internal structure of a recording device including a cutting device according to one exemplary embodiment.

FIG. 2 is a perspective view of a cutting mechanism.

FIG. 3 is a side view schematically illustrating main parts of the cutting device.

FIG. 4 is a side view schematically illustrating main parts of the cutting device.

FIG. 5 is a side view schematically illustrating main parts of the cutting device.

FIG. 6 is a side view schematically illustrating main parts of the cutting device.

### DESCRIPTION OF EXEMPLARY EMBODIMENTS

Hereinafter, with reference to the drawings, one a cutting device and a recording device including the cutting device according to one exemplary embodiment are described.

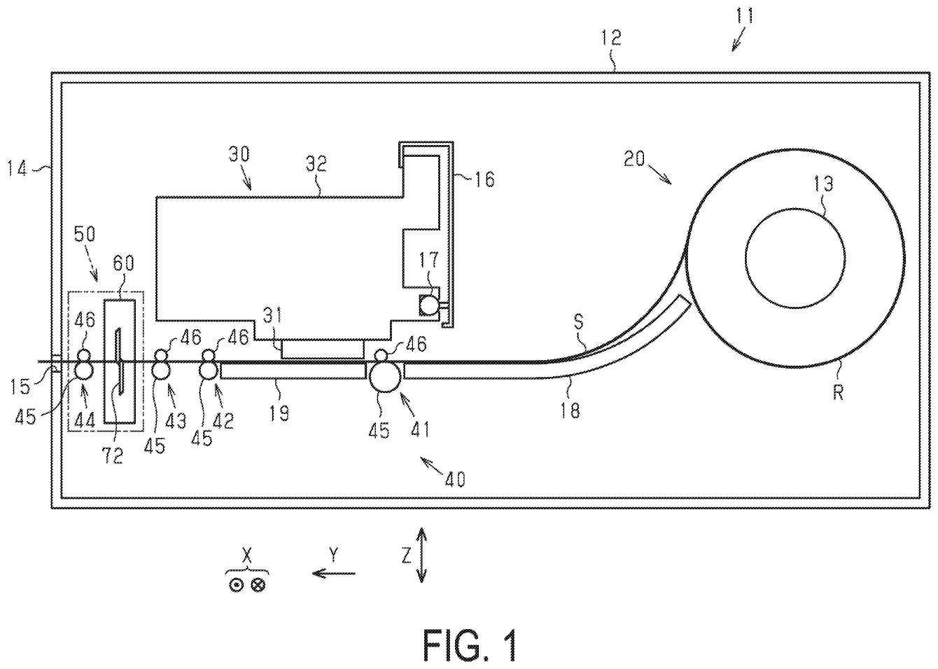

As illustrated in FIG. 1, a recording device 11 includes a rectangular parallel-piped housing 12. Normally, the housing 12 is installed on a plane extending horizontally. In the housing 12, there are provided a medium holding unit 20 that holds a medium S in a suppliable manner, a recording unit 30 that records an image such as a character and a picture onto the medium S, a transport unit 40 that transports the medium S, and a cutting device 50 that cuts the medium S.

In the housing 12, the medium holding unit 20 is provided on a rear side being a right side in FIG. 1. The medium holding unit 20 holds the medium S being, for example, an elongated sheet, in a form of a roll body R obtained by winding the medium S in a roll shape. The roll body R is rotatably supported by a shaft 13 provided to extend in a width direction X of the medium S. In the present exemplary embodiment, the medium S is unwound from the roll body R by rotating the shaft 13 in the counterclockwise direction in FIG. 1. The unwound medium S is transported to the recording unit 30 by the transport unit 40, and is subjected to recording by the recording unit 30. After that, the medium S is discharged from the housing 12 to the outside of the housing 12 through a discharge port 15 that opens to a front surface 14 of the housing 12.

In the present exemplary embodiment, a direction from the rear side being the right side in FIG. 1 to the front side being the left side corresponds to a transport direction Y of the medium S that is transported by the transport unit 40. The transport direction Y corresponds to a direction in which the medium S supported on a support table 19 is transported. The front surface 14 of the housing 12, which is a left side surface in FIG. 1, is a surface that spreads in a vertical direction Z and the width direction X. Here, an orthogonal coordinate system including three axes being an X axis, a Y axis, and a Z axis, is considered. The coordinate system is set in such a way that a plane on which the housing 12 of the recording device 11 is installed corresponds to a plane formed of the X axis and the Y axis and the front surface 14 of the housing 12 corresponds to a plane formed of the X axis and the Z axis. In this case, the width direction X is a direction along the X axis, the transport direction Y is a direction along the Y axis, and the vertical direction Z is a direction along the Z axis. Specifically, in the present exemplary embodiment, the width direction X, the transport direction Y, and the vertical direction Z indicate three directions orthogonal to one another.

The recording unit 30 includes, for example, a head 31 that jets liquid such as ink onto the medium S and a carriage 32 equipped with the head 31. The carriage 32 is supported by a frame member 16 provided in the housing 12 and a guide shaft 17 attached to the frame member 16. The guide shaft 17 extends in the width direction X of the medium S. The carriage 32 is movable along the guide shaft 17. Specifically, the carriage 32 is movable in the width direction X. The head 31 can eject liquid onto the medium S across the entire region in the width direction X by moving the carriage 32 along the guide shaft 17.

As illustrated in FIG. 1, a guide member 18 having a curved shape when viewed in the width direction X is arranged between the medium holding unit 20 and the recording unit 30 in the housing 12. The guide member 18 has a curved portion being an upstream portion from the midway in the length direction along the transport direction Y. The guide member 18 guides, the medium S, which is unwound from the roll body R of the medium holding unit 20 and is transported downstream, to the recording unit 30. Further, the support table 19 having a flat surface capable of supporting the medium S is arranged at a position facing the head 31 of the recording unit 30 from below in the vertical direction Z. Each of the guide member 18 and the support table 19 is formed of a plate-like member. A dimension of the plate-like member in the width direction X is equal to or greater than a maximum width dimension of the medium S to be used.

The transport unit 40 includes a first transport roller pair 41, a second transport roller pair 42, a third transport roller pair 43, and a fourth transport roller pair 44 in the transport direction Y. The first transport roller pair 41 is arranged upstream of the head 31 in the transport direction Y, and is arranged at a position between the guide member 18 and the support table 19. The second transport roller pair 42 and the third transport roller pair 43 are arranged downstream of the head 31 and upstream of the cutting device 50 in the transport direction Y. The fourth transport roller pair 44 is arranged directly before the discharge port 15 in the housing 12, and constitutes a part of the cutting device 50. Further, the fourth transport roller pair 44 is provided downstream of a cutter carriage 71, which is described later, in the transport direction Y.

The first to fourth transport roller pairs 41 to 44 each include a driving roller 45 that can be driven and rotated by a driving force from driving source such as a motor (not illustrated), and a driven roller 46 that can be driven and rotated by following rotation of the driving roller 45. Each of the first to fourth transport roller pairs 41 to 44 transports the medium S by rotating under a state in which the medium S is sandwiched between the driving roller 45 and the driven roller 46. The driving roller 45 is arranged to contact with the medium S from below, and the driven roller 46 is arranged to contact with the medium S from above.

Specifically, when transporting the medium S, the driven roller 46 of each of the second to fourth transport roller pairs 42 to 44 among the first to fourth transport roller pairs 41 to 44 contacts with a surface of the medium S onto which liquid is jetted. Thus, the driven roller 46 of each of the second to fourth transport roller pairs 42 to 44 is configured by a star wheel and the like having a small contact area with respect to the medium S in order to suppress degradation of quality of an image, which is recorded on the medium S by jetted ink or the like. Note that, in the present exemplary embodiment, a plurality of fourth transport roller pairs 44 are arranged at a predetermined interval in the width direction X. The same holds true to the first to third transport roller pairs 41 to 43.

As illustrated in FIG. 1, the cutting device 50 is configured to include a cutting mechanism 60 that cuts the medium S, and the fourth transport roller pair 44 being one example of a transport mechanism that transports the medium S, which is cut by the cutting mechanism 60, downstream in the transport direction Y. The cutting mechanism 60 is arranged between the third transport roller pair 43 and the fourth transport roller pair 44 in the transport direction Y. The medium S cut by the cutting mechanism 60 is transported downstream in the transport direction Y by the fourth transport roller pair 44, and hence is discharged from the discharge port 15 to the outside of the housing 12.

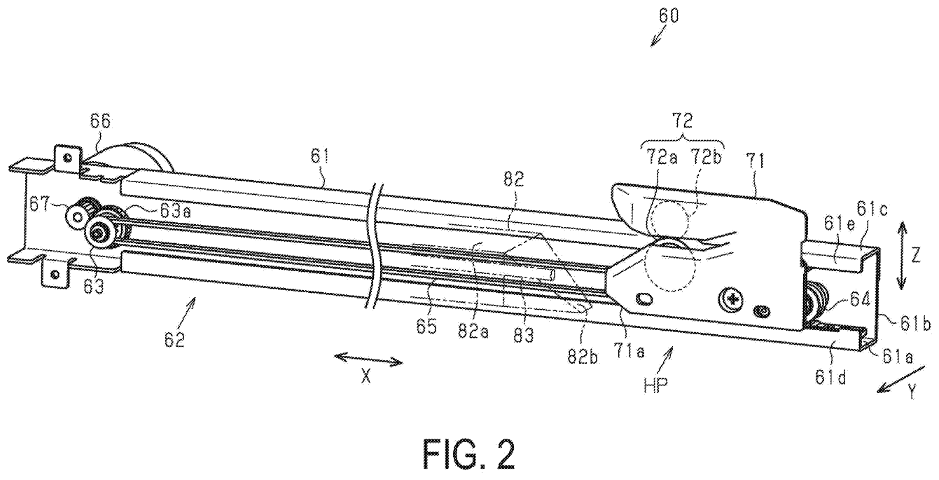

As illustrated in FIG. 2, the cutting mechanism 60 includes a frame 61 having a rail function, which is provided to extend along the width direction X, the cutter carriage 71 attached to be reciprocable along the frame 61, and a cutter blade 72 retained by the cutter carriage 71. The cutter carriage 71 is configured to reciprocate in the width direction X, which intersects the transport direction Y of the medium S, as a moving direction. The cutter blade 72 is configured to cut the medium S as the cutter carriage 71 moves to one side in the width direction X. Specifically, the cutting device 50 configured to include the cutting mechanism 60 includes the cutter carriage 71 including the cutter blade 72 capable of cutting the medium S. When the cutter carriage 71 moves from the right side to the left side in FIG. 2, the medium S is cut. The cutter blade 72 is configured by providing a driving blade 72a and a driven blade 72b that are arrayed in the vertical direction Z. The driving blade 72a is driven and rotated along movement of the cutter carriage 71, and the driven blade 72b is driven and rotated by following rotation of the driving blade 72a. Note that as illustrated in FIG. 2, an edge of the cutter carriage 71, which is a front edge in the moving direction at the time of cutting the medium S, and a lower edge thereof in the vertical direction Z intersects each other at a corner portion. The corner portion is chamfered to form an inclined surface portion 71a that is inclined upward with respect to the moving direction at the time of cutting the medium S.

A conductive rectangular metal plate is bent at a right angle at a linear part along a longitudinal direction, and thus is formed into a substantially rectangular tube-like shape having one opening surface when viewed from the longitudinal direction. In this manner, the frame 61 is obtained. Specifically, the frame 61 has a horizontal bottom wall 61a, a rear wall 61b that is bent and extends upward in the Z direction from a rear end of the bottom wall 61a, an upper wall 61c that is bent and extends frontward from an upper end of the rear wall 61b, and a lower front wall 61d and an upper front wall 61e that are bent and extend from a front end of the bottom wall 61a and a front end of the upper wall 61c, respectively, to face each other across a predetermined distance in the vertical direction Z. Note that a dimension of the frame 61 in the width direction X being the longitudinal direction is longer than a dimension of the medium S in the width direction X, and the cutter carriage 71 is attached on the front surface side of the frame 61 in such a way as to be reciprocable in the width direction X. Further, the conductive frame 61 is electrically coupled to the housing 12 or a main body frame (not illustrated) of the cutting device 50 through intermediation of a conductive member (not illustrated). Further, the conductive frame 61 is coupled to a ground terminal of an external power receptacle through intermediation of the housing 12 or the main body frame of the cutting device 50, and thus is grounded.

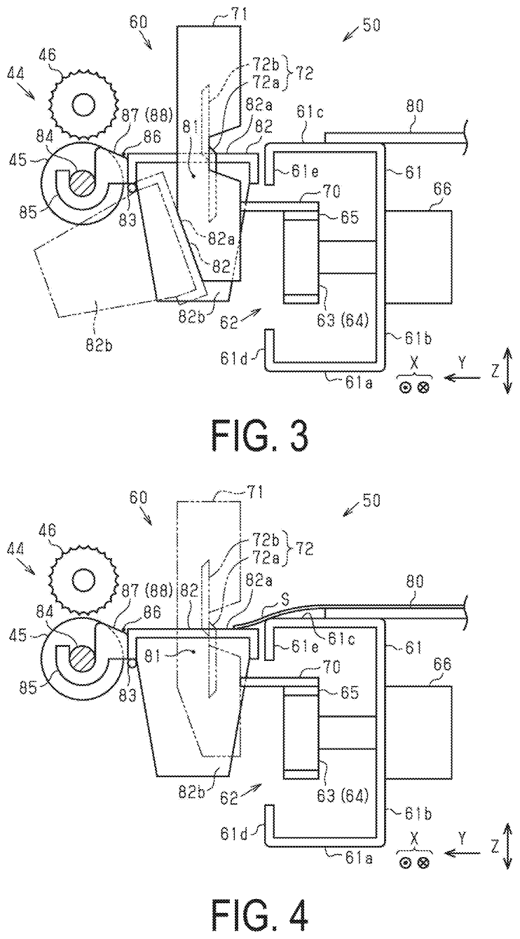

As illustrated in FIG. 2, on an inner side of the frame 61 where the front surface side opens between an upper edge of the lower front wall 61d and a lower edge of the upper front wall 61e, a driving unit 62 that is driven to cause the cutter carriage 71 to reciprocate in the width direction X is provided. The driving unit 62 includes pulleys 63 and 64 provided to both ends of the frame 61 in the width direction X, and an annular belt 65 wound between both the pulleys 63 and 64. Further, a toothed gear 63a that is provided to be integrally rotatable with the pulley 63 is attached coaxially with a rotary shaft of the pulley 63 provided to the left end of the frame 61 in FIG. 2. Further, the cutter carriage 71 is coupled to the belt 65 through intermediation of a coupling member 70 illustrated in FIG. 3.

Further, an electric motor 66 is provided on one end of the frame 61 in the width direction X, which is the left end in FIG. 2. A pinion 67 is attached to an output shaft of the electric motor 66, which protrudes inward of the frame 61. The electric motor 66 is attached to the frame 61 in such a way that the pinion 67 is engaged with the toothed gear 63a provided coaxially with the pulley 63. Specifically, the electric motor 66 drives and rotates the pinion 67, and thus the pulley 63 is rotated through intermediation of the toothed gear 63a with rotation of the pinion 67. Further, when the pulley 63 is rotated, the pulley 64 is rotated through intermediation of the belt 65, and thus the belt 65 is driven. When the belt 65 is driven, the cutter carriage 71 that retains the cutter blade 72 moves along the frame 61. Specifically, the driving unit 62 transmits driving of the electric motor 66 to the cutter carriage 71.

Next, the cutting device 50 is described.

As illustrated in FIG. 3, the cutting device 50 includes a support unit 80 upstream of the cutting mechanism 60 including the cutter carriage 71 in the transport direction Y of the medium S. The support unit 80 is capable of supporting the medium S transported downstream from the recording unit 30 by the transport unit 40. An upper surface of the support unit 80 is a plate-like member that forms a horizontal surface along the transport direction Y or a inclined surface that is gradually inclined downward in the transport direction Y. A downstream end of the support unit 80 in the transport direction Y contacts with an upper surface of the upper wall 61c of the frame 61. Specifically, the driving unit 62 that drives the cutter carriage 71 and the frame 61 that accommodates the driving unit 62 inside are arranged below the support unit 80 in the vertical direction Z being a height direction.

The downstream end of the support unit 80 is positioned rearward, that is, upstream of the front end of the upper wall 61c of the frame 61 in the transport direction Y of the medium S. Thus, a leading edge of the medium S that passes downstream in the transport direction Y through the downstream end of the support unit 80 contacts with the upper wall 61c of the frame 61. In this regard, the frame 61 functions as a contact portion capable of contacting with the medium S from below in the vertical direction Z being a height direction. Further, the support unit 80 is constituted of a conductive material such as metal and a conductive resin, and has electrical conductivity smaller than electrical conductivity of the frame 61. In other words, electrical conductivity of the frame 61 that contacts with the medium S is greater than electrical conductivity of the support unit 80.

As illustrated in FIG. 3, a passage region 81 is formed between the downstream end of the support unit 80 and the fourth transport roller pair 44 in the transport direction Y of the medium S, and functions as a moving space for the cutter carriage 71 reciprocating in the width direction X as the moving direction. When the leading edge of the medium S passes downstream in the transport direction Y through the passage region 81, the cutter carriage 71 stops at a home position HP illustrated in FIG. 2. Specifically, when the cutter carriage 71 is positioned at the home position HP, in a part where the passage region 81 is formed in a transport path of the medium S, a gap that the leading edge of the medium S transported downstream in the transport direction Y possibly enters is formed.

Thus, between the fourth transport roller pair 44 and the downstream end of the support unit 80, more specifically, the front end of the upper wall 61c of the frame 61 positioned downstream of the downstream end of the support unit 80 in the transport direction Y, a cover 82 capable of supporting the medium S by covering the passage region 81 is arranged. The cover 82 is supported to be switched between a first state and a second state. In the first state, as indicated with the solid line in FIG. 3, a support surface 82a is horizontal with respect to a support shaft 83 along the width direction X, and covers the passage region 81. In the second state, as indicated with the two-dot chain line in FIG. 3, the support surface 82a is inclined, and does not cover the passage region 81.

As indicated with the two-dot chain line in FIG. 2, at an end in the width direction X being the longitudinal direction, which is near the home position HP of the cutter carriage 71, the cover 82 has a inclined end surface 82b inclined downward to the home position HP side. Further, a biasing force of a biasing member (not illustrated) such as a torsion spring biases the cover 82 about the support shaft 83 as a rotation center from the position in the second state to the position in the first state, which is provided with a stopper (not illustrated). Further, when the medium S is cut, the inclined surface portion 71a of the cutter carriage 71, which passes through the passage region 81 from the home position HP side to the opposite side, presses the inclined end surface 82b. With this, the cover 82 rotates about the support shaft 83 as a rotation center, and hence the posture is switched from the first state to the second state.

Specifically, as indicated with the solid line in FIG. 3, in the first state of covering the passage region 81, the cover 82 is capable of supporting, with the support surface 82a, the medium S transported downward in the transport direction Y across the passage region 81. Meanwhile, the cover 82 is retracted from the position in the first state to the position in the second state while the cutter carriage 71 moves through the passage region 81 from the home position HP side to the opposite side. With this, the passage region 81 opens. Specifically, the cover 82 is retracted from the position in the first state to the position in the second state, and hence the cutter carriage 71 reciprocates in the passage region 81 from the home position HP in the width direction X along the frame 61. With this, the cutter carriage 71 can pass through the passage region 81.

As illustrated in FIG. 3, the driving roller 45 of the fourth transport roller pair 44 is provided downstream of a downstream end of the cover 82 in the first state in the transport direction Y of the medium S. The driving roller 45 includes a rotary shaft 84 that is integrally rotated with the driving roller 45 and protrudes in the X direction with respect to the driving roller 45. A geometrical center of the rotary shaft 84 matches with a geometrical center of the driving roller 45. Further, the driving roller 45 is provided to have an uppermost part of a circumferential surface in the vertical direction Z, which is positioned slightly above the support surface 82a of the cover 82 in the Z direction. Specifically, at a position slightly below the support surface 82a of the cover 82 in the first state in the Z direction, the rotary shaft 84 is rotatably supported by a bearing portion 85 that has an upper side opening in the Z direction. Further, the driving roller 45 of the fourth transport roller pair 44 is coupled to and driven by a driving source (not illustrated), is rotated while sandwiching, with the driven roller 46, the medium S cut by the cutting mechanism 60, and thus transports the medium S downstream in the transport direction Y.

Further, the rotary shaft 84 is arranged downstream of the support shaft 83 in the transport direction Y. In other words, the rotary shaft 84 does not have a function of the support shaft 83. Even when the rotary shaft 84 functions as the support shaft 83, the cover 82 slides with the rotary shaft 84 more than necessary. With this, there is a risk of wearing out the cover 82. In the present exemplary embodiment, a configuration in which the rotary shaft 84 does not have a function of the support shaft 83 is employed, and thus wearing of the cover 82 can be suppressed.

Further, a part of the bearing portion 85 that supports the rotary shaft 84 of the driving roller 45, which is positioned upstream of the rotary shaft 84 in the transport direction Y of the medium S, is arranged in a gap 86 between the downstream end of the cover 82 and the driving roller 45. Specifically, the part of the bearing portion 85, which is positioned upstream of the rotary shaft 84, functions as an abutting portion 87 abutting on the medium S from below in the Z direction when the leading edge of the medium S passes downstream in the transport direction Y through the downstream end of the cover 82. Further, the abutting portion 87 has an inclined surface 88 that is inclined upward to the circumferential surface of the driving roller 45, which is positioned downstream of the abutting portion 87 in the transport direction Y. In other words, the abutting portion 87 has an abutting surface capable of abutting on the medium S, and the abutting surface corresponds to the inclined surface 88 inclined upward in the transport direction Y. Note that the abutting surface of the abutting portion 87 is not required to be the inclined surface 88 inclined upward. Specifically, the abutting surface of the abutting portion 87 may be a horizontal surface parallel with the transport direction Y or a curved surface.

Note that, when the downstream end of the cover 82 has a recess and a protrusion arrayed in the width direction X, a distal end of a protruding portion, which is positioned most downstream in the transport direction Y of the medium S, corresponds to the downstream end of the cover 82. Further, the gap 86 is formed between the downstream end of the cover 82 in the transport direction Y of the medium S and the circumferential surface of the driving roller 45.

Next, the functions of the exemplary embodiment described above are described.

Now, the medium S on which an image is recorded by ink jetted from the head 31 of the recording unit 30 is transported to the cutting device 50, which is positioned downstream in the transport direction Y, by the transport unit 40, and thus is cut by a predetermined length including the image recording part. Further, the medium S may have a curl, which is caused by absorbing liquid such as ink jetted for image formation, and the leading edge thereof may hang downstream in the transport direction Y in some cases when being transported. Thus, when a space that the leading edge of the medium S, which is in a forwardly descending state, may possible enter is present downstream of the recording unit 30 in the transport direction Y of the medium S in the transport path of the medium S, there may be a risk of hindering satisfactory transport of the medium S, which is performed by the transport unit 40.

In this regard, as illustrated in FIG. 4, the leading edge of the medium S transported to the cutting device 50 positioned downstream of the recording unit 30 is supported from below in the Z direction by the upper wall 61c of the frame 61 functioning as a contact portion when being transported to the support surface 82a of the cover 82 in the first state, which is positioned downstream of the support unit 80. Thus, the medium S is satisfactorily received from the support unit 80 to the cover 82 in the transport direction Y because the upper wall 61c of the frame 61 supports the medium S from below.

Further, in the middle of being transported downstream from the recording unit 30 to the cutting device 50, the medium S may be electrically charged in some cases due to sliding with the support unit 80 and the like. In this case, there may be a risk of hindering satisfactory transport of the medium S due to electrical charging. For example, after the medium S is received by the cover 82 from the support unit 80, the medium S adheres to the support surface 82a, and transport resistance of the medium S is increased. With this, there is a risk in that the medium S is not normally discharged. However, in the present exemplary embodiment, the frame 61 that is to contact with the medium S downstream of the support unit 80 in the Z direction has electrical conductivity greater than the support unit 80, and is grounded. Thus, by the time of arriving at the cover 82 positioned downstream, static elimination is performed for the medium S that is electrically charged. As described above, in the present exemplary embodiment, the upper surface of the upper wall 61c of the frame 61 is utilized as a path when the medium S is received by the cover 82 downstream from the support unit 80.

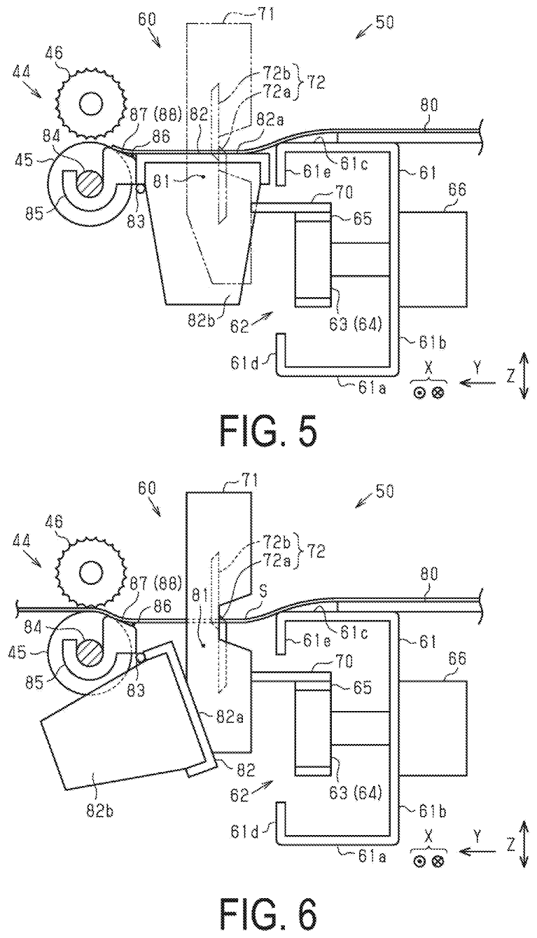

After that, as illustrated in FIG. 5, after the leading edge arrives at the support surface 82a of the cover 82, the medium S abuts on the abutting portion 87 being a part of the bearing portion 85, in the middle of moving downstream from the support surface 82a to the driving roller 45. Specifically, above the gap 86 between the downstream end of the cover 82 and the driving roller 45, the leading edge of the medium S is lifted upward in the vertical direction Z by the abutting portion 87 abutting from below in the Z direction. Moreover, at this moment, the inclined surface 88 of the abutting portion 87, which is inclined upward to the driving roller 45 downstream in the transport direction Y, abuts on the leading edge of the medium S from below. Thus, the leading edge of the medium S is transported along the inclined surface 88 to the circumferential surface of the driving roller 45.

After that, as illustrated in FIG. 6, after the leading edge is transported downstream of the fourth transport roller pair 44, which is positioned most downstream in the transport unit 40, the medium S is cut by the cutting mechanism 60. At this moment, the posture of the cover 82 is switched from the first state to the second state when the cutter carriage 71 moves from the home position HP through the passage region 81 in the width direction X. Specifically, in the middle of moving, the cutter carriage 71 causes the inclined surface portion 71a to abut on the inclined end surface 82b of the cover 82, and further moves through the passage region 81 while being in the abutting state. With this, the cover 82 is switched from the first state to the second state by rotating about the support shaft 83 as a rotation center. Further, when the cutter carriage 71 moves through the passage region 81 in the width direction X as described above, the medium S is cut by the cutter blade 72 retained by the cutter carriage 71.

Next, the effects of the exemplary embodiment described above are described.

(1) The leading edge passes downstream in the transport direction Y of the medium S through the downstream end of the cover 82. Then, above the gap 86 between the downstream end of the cover 82 and the driving roller 45 of the fourth transport roller pair 44 being a transport mechanism, the abutting portion 87 abuts on the medium S from below in the vertical direction Z. Thus, the medium S is lifted upward in the vertical direction Z by the abutting portion 87 abutting from below. With this, the medium S is easily received by the driving roller 45 of the fourth transport roller pair 44 being a transport mechanism, from the cover 82.

(2) Above the gap 86 between the downstream end of the cover 82 and the driving roller 45 of the fourth transport roller pair 44, the inclined surface 88 of the abutting portion 87, which is inclined upward, abuts on the leading edge of the medium S from below. Thus, receiving performance of the medium S from the cover 82 to the driving roller 45, which is achieved by the abutting portion 87, is further improved.

(3) A part of the bearing portion 85 of the driving roller 45 of the fourth transport roller pair 44 constituting a transport mechanism constitutes the abutting portion 87. Thus, the abutting portion 87 can be positioned in the vicinity of the driving roller 45. Thus, receiving performance of the medium S from the cover 82, which is positioned upstream in the transport direction Y, to the driving roller 45, which is positioned downstream, via the abutting portion 87 is further improved.

(4) Between the downstream end of the support unit 80 and an upstream end of the cover 82, the medium S is supported by the frame 61 being a contact portion contacting from below. Thus, the medium S is satisfactorily received from the support unit 80, which is positioned upstream, to the cover 82, which is positioned downstream, in the transport direction Y.

(5) Even when the medium S is electrically charged due to sliding with the support unit 80, contact with the frame 61 functioning as a contact portion can eliminate static electricity from the medium S to the outside of the cutting device 50. Specifically, by the time of being received from the support unit 80 to the cover 82, static elimination is performed for the medium S. Therefore, a transport failure, which is caused by the medium S adhering to the cover 82 or the transport path thereafter, can be suppressed.

(6) The upper surface of the upper wall 61c of the frame 61 that accommodates the driving unit 62 of the cutter carriage 71 can be utilized as a path when the medium S is received by the cover 82 downstream from the support unit 80. Thus, a simple configuration enables the medium S to be received easily from the support unit 80 to the cover 82, without providing a new material.

The present exemplary embodiment may be modified as follows. The present exemplary embodiment and modified examples thereof to be described below may be implemented in combination within a range in which a technical contradiction does not arise.

Between the downstream end of the support unit 80 and the upstream end of the cover 82, a conductive grounded contact portion may be constituted of a member that is provided independently from the frame 61 accommodating the driving unit 62 of the cutter carriage 71.

Electrical conductivity of the frame 61 constituting the contact portion may be the same as electrical conductivity of the support unit 80.

The downstream end of the support unit 80 extends downstream of the front end of the upper wall 61c of the frame 61 in the transport direction Y. With this, the medium S may be satisfactorily received from the support unit 80, which is positioned upstream, to the cover 82, which is positioned downstream, in the transport direction Y.

The abutting portion 87 may be constituted of a member independently from the bearing portion 85 of the driving roller 45 of the fourth transport roller pair 44 constituting a transport mechanism.

The abutting portion 87 may abut on the leading edge of the medium S from below with an arc surface that is inclined upward and downstream in the transport direction Y, in place of the inclined surface 88.

In place of the inclined surface 88, the abutting portion 87 may be constituted of a plurality of bars along the transport direction Y, each of which is provided to be inclined in such a way that a downstream end in the transport direction Y is positioned on an upper side in the vertical direction Z with respect to an upstream end.

The cover 82 may have a configuration of being electrically switched from the first state to the second state, in place of a configuration being pressed by the cutter carriage 71 that moves through the passage region 81 in the width direction X.

The transport mechanism that is provided downstream of the cutter carriage 71 and transports the medium S in the transport direction Y may transport the medium S with a belt mechanism in place of transporting the medium S with the roller pairs. The cutting device 50 may be arranged upstream of the recording unit 30 in the transport direction Y. Further, the cutting device 50 may be a unit independent from the recording device 11.

Hereinafter, technical concepts and effects thereof that are understood from the above-described exemplary embodiment and modified examples are described.

(A) A cutting device includes a cutter carriage including a cutter blade configured to cut a medium, and being provided movably in a moving direction intersecting a transport direction in which the medium is transported, a transport mechanism being provided downstream of the cutter carriage in the transport direction, and being configured to transport the medium in the transport direction, a support unit being provided upstream of the cutter carriage in the transport direction, and configured to support the medium, a cover being provided in a switchable manner between a first state and a second state, the first state being a state in which the cover is configured to support the medium by covering a passage region for the cutter carriage that is formed between a downstream end of the support unit in the transport direction and the transport mechanism, the second state being a state in which the cover opens the passage region by retracting from a position in the first state, and an abutting portion being arranged in a gap formed between a downstream end of the cover in the transport direction and the transport mechanism, and being configured to abut on the medium from below in a height direction intersecting the transport direction and the moving direction.

With this configuration, when the leading edge passes downstream through the downstream end of the cover in the transport direction, the medium is lifted upward in the height direction by the abutting portion that abuts on the medium from below, above the gap between the downstream end of the cover and the transport mechanism. Thus, the medium is easily received from the cover to the transport mechanism.

(B) In the cutting device described above, the abutting portion may have an inclined surface inclined upward toward the transport mechanism positioned downstream in the transport direction.

With this configuration, above the gap between the downstream end of the cover and the transport mechanism, the inclined surface of the abutting portion, which is inclined upward, abuts on the leading edge of the medium from below. Thus, receiving performance of the medium to the transport mechanism is further improved.

(C) In the cutting device described above, the transport mechanism may include a driving roller configured to be coupled to and driven by a driving source, and the abutting portion may a part of a bearing portion configured to support a rotary shaft of the driving roller.

With this configuration, the abutting portion can be positioned in the vicinity of the driving roller constituting the transport mechanism. Thus, receiving performance of the medium from the cover, which is positioned upstream in the transport direction, to the driving roller, which is positioned downstream, via the abutting portion is further improved.

(D) The cutting device described above may further include a contact portion between the downstream end of the support unit and an upstream end of the cover in the transport direction, the contact portion being capable of contacting with the medium from below in the height direction.

With this configuration, above the downstream end of the support unit and the upstream end of the cover, the medium is supported by the contact portion contacting from below. Thus, the medium is satisfactorily received from the support unit, which is positioned upstream, to the cover, which is positioned downstream, in the transport direction.

(E) In the cutting device described above, electrical conductivity of the contact portion may be greater than the electrical conductivity of the support unit.

With this configuration, even when the medium is electrically charged due to sliding with the support unit, contact with the contact portion can eliminate static electricity from the medium to the outside of the cutting device. Specifically, by the time of being received from the support unit to the cover, static elimination is performed for the medium. Therefore, a transport failure, which is caused by the medium adhering to the cover or the transport path thereafter, can be suppressed.

(F) In the cutting device described above, a driving unit configured to drive the cutter carriage and a frame configured to accommodate the driving unit may be arranged below the support unit in the height direction, and the frame may correspond to the contact portion.

With this configuration, the upper surface the frame that accommodates the driving unit of the cutter carriage can be utilized as a path when the medium is received from the support unit to the cover. Thus, a simple configuration enables the medium to be received easily from the support unit to the cover, without providing a new material.

(G) A recording device including the cutting device described above, and a recording unit configured to perform recording onto the medium.

With this configuration, the effects of the cutting device can be exerted in the recording device.

What is claimed is:

1. A cutting device, comprising:
a cutter carriage including a cutter blade configured to cut a medium, and being provided movably in a moving direction intersecting a transport direction in which the medium is transported;
a transport mechanism being provided downstream of the cutter carriage in the transport direction, and being configured to transport the medium in the transport direction;
a support unit being provided upstream of the cutter carriage in the transport direction, and configured to support the medium;
a cover being provided in a switchable manner between a first state and a second state, the first state being a state in which the cover is configured to support the medium by covering a passage region for the cutter carriage that is formed between a downstream end of the support unit in the transport direction and the transport mechanism, the second state being a state in which the cover opens the passage region by retracting from a position in the first state; and
an abutting portion being arranged in a gap formed between a downstream end of the cover in the transport direction and the transport mechanism, and being configured to abut on the medium from below in a height direction intersecting the transport direction and the moving direction.

2. The cutting device according to claim 1, wherein
the abutting portion has an inclined surface inclined upward toward the transport mechanism positioned downstream of the abutting portion in the transport direction.

3. The cutting device according to claim 1, wherein
the transport mechanism includes a driving roller configured to be coupled to and driven by a driving source, and
the abutting portion is a part of a bearing portion configured to support a rotary shaft of the driving roller.

4. The cutting device according to claim 1, comprising:
a contact portion between the downstream end of the support unit and an upstream end of the cover in the transport direction, the contact portion being configured to contact the medium from below in the height direction.

5. The cutting device according to claim 4, wherein
electrical conductivity of the contact portion is greater than the electrical conductivity of the support unit.

6. The cutting device according to claim 4, wherein
a driving unit configured to drive the cutter carriage and a frame configured to accommodate the driving unit are arranged below the support unit in the height direction, and the frame is the contact portion.

7. The cutting device according to claim 1, wherein
the cover is switched from the first state to the second state as the cutter carriage moves in a cutting/moving direction from a home position so that the cutter blade cuts the medium.

8. The cutting device according to claim 7, wherein
the cover has, at an end on the home position side, an inclined end surface inclined downward toward the home position side, and
the cover is switched from the first state to the second state, when a part of the cutter carriage abuts on the inclined end surface and presses down the inclined end surface as the cutter carriage moves in the cutting/moving direction from the home position.

9. The cutting device according to claim 8, wherein
the cover is switched from the first state to the second state by rotating about a support point on a downstream side thereof in the transport direction.

10. A recording device, comprising:
the cutting device according to claim 1; and
a recording unit configured to perform recording onto the medium.
